(19) United States
(12) Patent Application Publication
(10) Pub. No.: US 2012/0006643 A1
(43) Pub. Date: Jan. 12, 2012

(54) DOUBLE-ACTING SYNCHRONIZER

(75) Inventors: Jan Sporleder, Ingelheim (DE); Joerg Appelshaeuser, Mainz (DE); Hans-Juergen Zuck, Eltville (DE); Theodore Kokx, Mainz (DE)

(73) Assignee: GM GLOBAL TECHNOLOGY OPERATIONS LLC, Detroit, MI (US)

(21) Appl. No.: 13/255,011

(22) PCT Filed: Jan. 22, 2010
(86) PCT No.: PCT/EP2010/000370

§ 371 Date: Sep. 6, 2011

(30) Foreign Application Priority Data
Mar. 6, 2009 (GB) 0903884.5

(51) Int. Cl. F16D 23/06

(52) U.S. Cl. 192/53.341

(57) ABSTRACT

A double-acting synchronizer includes, but is not limited to a shaft, first and second gearwheels rotatably mounted on said shaft, a sleeve which is axially displaceable along said shaft between a position in which it locks the first gearwheel to the shaft and a position in which it locks the second gearwheel to the shaft. A single conical friction surface is formed between a first baulk ring and the first gearwheel, and multiple nested conical friction surfaces are formed between a second baulk ring and the second gearwheel.

### CROSS-REFERENCE TO RELATED APPLICATIONS

This application is a U.S. National-Stage entry under 35 U.S.C. § 371 based on International Application No. PCT/EP2010/000370, filed Jan. 22, 2010, which was published under PCT Article 21(2) and which claims priority to British Application No. 0903884.5, filed Mar. 6, 2009, which are all hereby incorporated in their entirety by reference.

### TECHNICAL FIELD

The technical field relates to a double-acting synchronizer and to a transmission, in particular for a motor vehicle, in which the synchronizer is used.

### BACKGROUND

A double-acting synchronizer conventionally has a hub which is splined to a shaft which also carries two gearwheels to which the synchronizer is associated. A sleeve is axially displaceable along the shaft between a neutral position and displaced positions in which it locks one of the two gearwheels to the shaft. Dog teeth of the sleeve cannot engage with the gearwheels as long as these have a rotation speed which is substantially different from that of the shaft. In order to prevent the dog teeth from grinding on the gearwheels, a baulk ring is provided between the hub and each gearwheel. If the sleeve is no doubt of its neutral position, it displaces the baulk ring, causing the associated gearwheel to synchronize to the shaft by friction. Only when synchronization is achieved, the baulk ring assumes a position in which dog teeth of the sleeve can pass through gaps of the baulk ring and engage with the gearwheel.

According to a first conventional type of synchronizer, baulk rings have a hollow cone which mates with a solid cone of an associated gearwheel, so that friction occurs directly between the mating conical surfaces of baulk ring and gearwheel. The wear of the friction surfaces is related to their size. The smaller the contact area between the gearwheel and the baulk ring is, the more it will be heated in a synchronization process and the stronger is its wear. The size of the contact surface might be increased by increasing the axial and/or radial dimensions of the cones, but package size requirements impose strict limits for these dimensions.

A larger contact surface might be provided in a synchronizer of limited dimensions if friction surfaces could be nested. A synchronizer is known in which nested rings are arranged between a synchronizer hub and a gearwheel. In order to distribute the friction load, an inner one of the two rings must be locked in rotation to the synchronizer hub, whereas the other ring is locked to the gearwheel. An indexing mechanism between each friction ring and the component to which it is locked occupies space in the axial direction, so that if a synchronizer of this type is to fit in the same space as a synchronizer with direct contact between sleeve and gearwheel, the axial dimension of the contact area must be reduced in order to accommodate the indexing mechanism, so that only a small increase of the total area of contact or no increase at all may be achieved.

Therefore, neither of the two types of synchronizer is the ideal solution for designing an extremely compact transmission.

In view of the foregoing, at least one objective is to provide a synchronizer enabling to design an extremely compact transmission, and a compact transmission using such a synchronizer. In addition, other objectives, desirable features and characteristics will become apparent from the subsequent detailed summary and description, and the appended claims, taken in conjunction with the accompanying drawings and this background.

### SUMMARY

According to a first embodiment, the problem is solved by a double-acting synchronizer comprising a shaft, first and second gearwheels rotatably mounted on the shaft, a sleeve which is axially displaceable along said shaft between a position in which it locks the first gear to the shaft and a position in which it locks the second gear to the shaft. A single conical friction surface is formed between a first baulk ring and a first gearwheel, and multiple concentric conical friction surfaces are formed between a second baulk ring and a second gearwheel.

Conventionally, the baulk ring may have dog teeth with oblique facets facing the sleeve, so that when the sleeve is displaced, it will come to contact with the oblique facets, and when synchronization is reached, pressure of the sleeve on the oblique facets causes the baulk ring to turn into a position in which the sleeve can pass by it and engage a gearwheel.

In order to rotate the baulk ring, the friction between it and the gearwheel must be overcome. If there are multiple friction surfaces between the baulk ring and its associated gearwheel, this friction will be stronger than in case of direct contact between the baulk ring and its associated gearwheel. This may cause shifting forces to differ depending on the direction in which the sleeve is displaced, which may be a nuisance to the driver. In order to have substantially identical shifting forces in both directions, it is preferred that the facets of the second baulk ring are steeper than those of the first baulk ring.

Conversely or additionally, dog teeth of the sleeve may have oblique facets facing the baulk rings, and those of the facets which face the second baulk ring are steeper than those which face the first baulk ring.

If an actuator is provided for driving a displacement of the synchronizer sleeve, higher shifting forces are acceptable than in the case of a manually shifted gearbox.

Therefore, the facing facets of baulk rings and/or shifting sleeve can be made rather flat, whereby the axial dimension of the synchronizer can be reduced further.

Preferably, the facets form a roof angle of at least approximately 50°, more preferably between approximately 55° and approximately 60° with respect to the direction of displacement of the sleeve.

If the roof angles of first and second baulk rings are identical, a symmetrical sleeve can be used, facilitating the assembly of the gearbox. Eventually, a same type of baulk ring can be used at either side of the synchronizer, whereby the assembly is simplified further.

The second baulk ring and a friction ring concentrically locked to the second baulk ring may form an angular groove. In that case the side walls of the groove may form two of said concentrical conical friction surfaces. A friction surface may also be formed at an inner surface of the friction ring.

If the friction ring is in direct form-fitting engagement with a hub of the synchronizer, the axial dimension of the synchronizer can be reduced compared to a synchronizer where the friction ring engages the second baulk ring.

The at least one objective is further achieved by a transmission comprising at least one synchronizer of the above described type. In such a transmission, a gear associated to the second gearwheel is preferably lower than a gear associated to the first gearwheel. Since inertia is usually higher for low gears, the friction load tends to be higher at the second gearwheel than at the first. By providing multiple friction surfaces at the second gearwheel, friction wear is reduced, whereas at high gears, at which inertia is lower, the synchronizer may be made very compact by not using multiple nested friction surfaces.

### BRIEF DESCRIPTION OF THE DRAWINGS

The present invention will hereinafter be described in conjunction with the following drawing figures, wherein like numerals denote like elements, and:

FIG. 1 is an exploded view of a synchronizer according to an embodiment of the present invention;

FIG. 2 is a partial section of a transmission using the synchronizer shown in FIG. 1;

FIG. 3 is a partial section of the same transmission, the section plane being rotated with respect to that of FIG. 2;

FIG. 4 is a section of dog teeth of the synchronizer according to a second embodiment of the invention;

FIG. 5 is a partial section of a transmission using a synchronizer according to a third embodiment of the invention; and

FIG. 6 is a partial section of the transmission of FIG. 5, the section plane being rotated with respect to that of FIG. 5.

### DETAILED DESCRIPTION

The following detailed description is merely exemplary in nature and is not intended to limit application and uses. Furthermore, there is no intention to be bound by any theory presented in the preceding background or summary or the following detailed description.

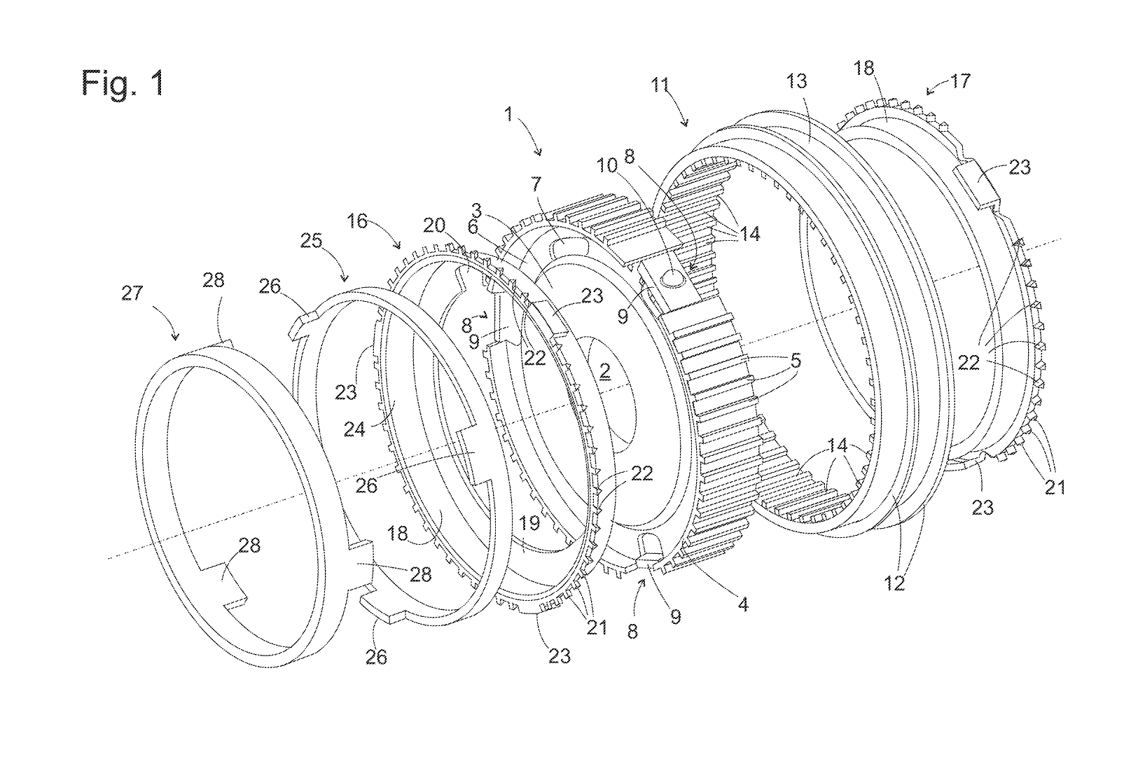

FIG. 1 is an exploded view of a double-acting synchronizer according to the present invention. The synchronizer comprises a central hub 1 which is adapted to be non-rotatably splined to a shaft, not shown, extending through a central bore 2 of hub 1. A central portion of the hub is in the shape of a circular disk 3, and a tubular portion 4 carrying dog teeth 5 extends along the circumference of disk 3. Near the periphery of disk 3, a circular groove 6 is formed in the disk 3, and inside the groove 6, three shallow depressions 7 are formed. Only one of these depressions 7 is visible in FIG. 1.

Three cutouts 8 are formed in the tubular portion 4 and extend well into the circular groove 6 of disk 3. Inside the cutouts 8 pressurizing blocks 9 are located, each of which comprises a ball 10 which is urged radially outward by a spring, not shown.

A tubular sleeve 11 has two circumferential webs 12 at its circumference which form a groove 13 for engagement by a shifting fork, not shown. The shifting fork may be driven by force transmitted mechanically from a driver-operated shift lever, or an actuator may be provided for power-assisted or automatic shifting.

Inwardly directed dog teeth 14 of sleeve 11 match with outwardly directed dog teeth 5 of hub 1, guiding sleeve 11 non-rotatably in the axial direction. Dog teeth 14 which face one of spring-loaded balls 10 have a central notch, not shown in FIG. 1, into which the ball 10 is urged by the spring, so that when the sleeve 11 is displaced in the axial direction, the pressurizing blocks 9 will follow to a certain extent.

At either side of hub 1, a baulk ring 16, 17 is provided. The two baulk rings 16, 17 each have a short tubular portion 18 which engages a central cavity at either side of the hub 1. In case of ring 16, a radially inwardly directed web 19 is formed at one end of tubular portion 18 engaging the cavity of hub 1. The web 19 has three cutouts 20 at positions matching the flat depressions 7. At the opposite end of tubular portion 18, dog teeth 21 extend in a radially outward direction. The dog teeth 21 have a triangular cross section with two oblique facets 22 at a side facing hub 1. Three hooks 23 of the baulk rings 16, 17 engage the cutouts 8 at either side of pressurizing blocks 9, defining a limited freedom of rotation of the baulk rings 16, 17 with respect to the hub 1.

The rear baulk ring 17 of FIG. 1 has a conical inner friction surface for direct contact with a gearwheel, whereas a conical inner friction surface 24 of ring 16 surrounds a first friction ring 25. Friction ring 25 has three indexing fingers 26 for locking engagement with a gearwheel, not shown. Inside friction ring 25, a second friction ring 27 is nested, indexing fingers 28 of which extend through the cutouts 20 of baulk ring 16 and are lockingly received in depressions 7 of hub 1. The cutouts 20 are somewhat larger than depressions 7, so that when friction ring 27 is subject to external torque, this torque will be transmitted to hub 1 directly by the indexing fingers 28 pressing against sidewalls of depressions 7. Since web 19 is not needed for receiving torque from friction ring 27, it may be rather thin, or it may be missing completely, as shown for rear baulk ring 17.

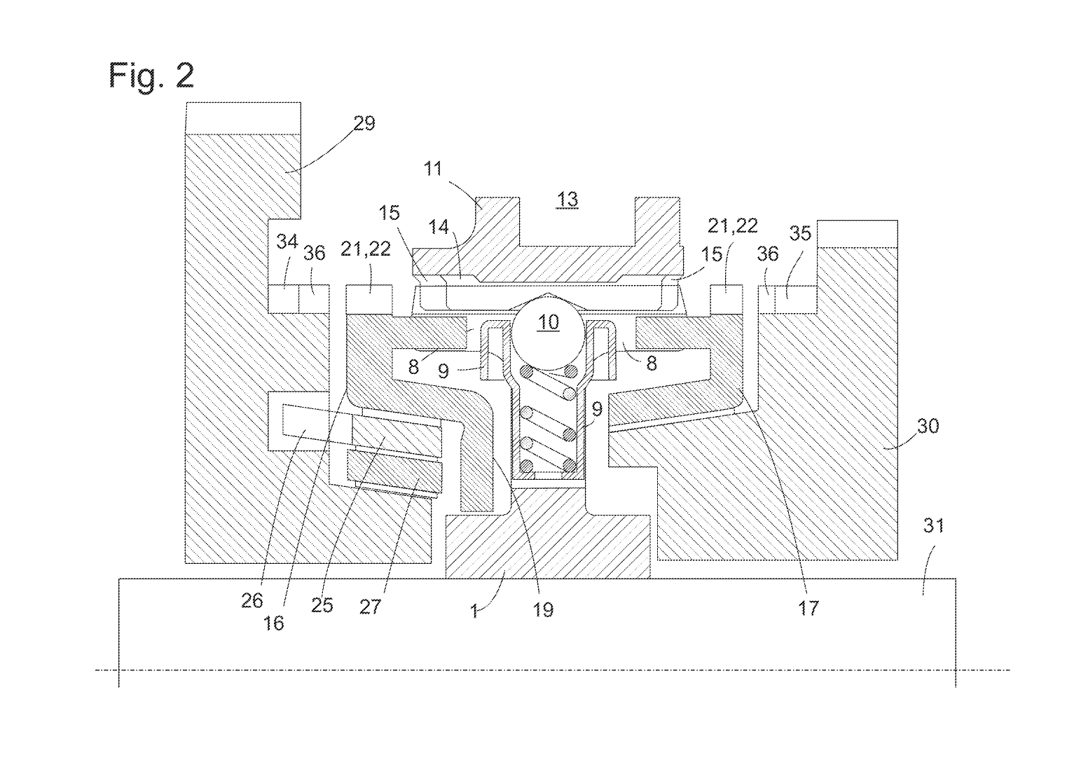

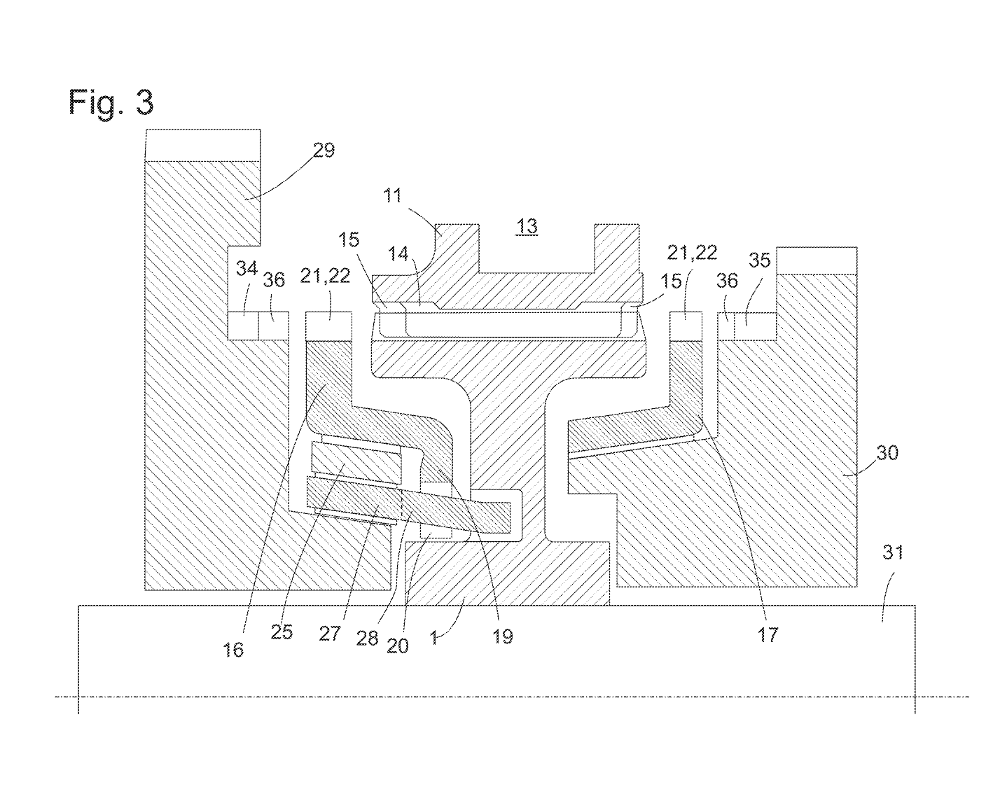

Cross sections of the double-acting synchronizer of FIG. 1 and of gearwheels 29, 30 associated to it are shown in FIGS. 2 and 3. In FIG. 2, the section plane extends from the axis of rotation of the synchronizer through one of cutouts 8 of shaft 1 and the pressurizing block 9 mounted therein, in FIG. 3 it extends from the axis of rotation through one of cutouts 20 and indexing fingers 28. Reference numeral 31 denotes a layshaft of a motor vehicle transmission on which the synchronizer and the gearwheels 29, 30 are mounted. The spring loaded ball 10 holds sleeve 11 in the neutral position as shown in FIG. 2. If the sleeve 11 is displaced to the right, it urges baulk ring 17 towards gearwheel 30, so that inner surface 24 of baulk ring 17 can get into contact with a friction lining 32 at a conical surface 33 of gearwheel 30. Ring 17 is rotated until its hooks 23 abut against the sides of cutouts 8 of hub 1. In this configuration, facing facets 22, 15 of dog teeth 21, 14 are in contact with each other, and the dog teeth 21 of ring 17 prevent further displacement of sleeve 11. When the gearwheel 30 is synchronized and applies no more torque to baulk ring 17, the latter is free to rotate under axial pressure from the sleeve 11, and the sleeve 11 engages teeth 35 of gearwheel 30. Similar to dog teeth 14, 21, the teeth 35 may have oblique facets 36 facing hub 1.

At the left hand side of FIG. 2 and FIG. 3, the two friction rings 25, 27 are shown in section between baulk ring 16 and gearwheel 29. If the sleeve 11 is displaced from the neutral position to the left, drags along pressurizing blocks 9, causing these to abut against hooks 23 of baulk ring 16 and thus displacing baulk ring 16 to the left. Friction then occurs not at one but at three pairs of matching conical surfaces between baulk ring 16, friction rings 25, 27 and gearwheel 29. This friction causes baulk ring 16 to rotate with respect to hub 1 until the sides of hooks 23 abut against the sides of the gaps formed in tubular portion 4. In this orientation, dog teeth 14 and 21 of sleeve 11 and baulk ring 16 overlap, so that when the sleeve 11 is displaced further, contact between the teeth 14, and 21 will urge baulk ring 16, friction rings 25, 27 and gearwheel 29 firmly against one another until synchronization is reached.

Since the friction between baulk ring 16, friction rings 25, 27 and gearwheel 29 is much stronger than between baulk ring 17 and gearwheel 30, the facets 15, 22 and, eventually, facets 36 of teeth 34 of gearwheel 16, are made considerably steeper at the left hand side of the hub 1 than at its right hand side, adding to the axial length of the left hand part of the synchronizer.

This extra width is worth wile in case of the left hand portion of the synchronizer, since gearwheel 29, having large diameter, is associated to a low gear of the transmission, synchronization of which involves overcoming a rather high inertia, whereas gearwheel 30, being a much smaller diameter, is associated to a high gear of the transmission where inertia is low, and, hence, friction load is low when a synchronization takes place. Without the friction rings 25, 26 in the left hand portion of the synchronizer, friction surfaces between ring 16 and gearwheel 29 would have to be very broad, and space is saved by providing multiple pairs of friction surfaces by means of the rings 25, 27. On the other hand, if friction rings had been provided in the left hand portion of the synchronizer, too, additional space would have been required for accommodating the steep facets that would have become necessary in that case, so that here a direct contact between ring 17 and gearwheel 30 is the most compact solution.

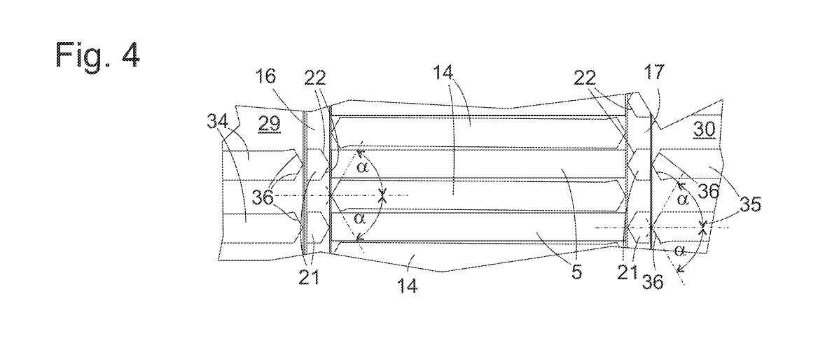

A second embodiment differs from the one described above referring to FIGS. 1 to 3 by the fact that sleeve 11 is coupled to an actuator, and by the shape of the interacting dog teeth 14, 21, 34, 35 of sleeve 11, baulk rings 16, 17 and gearwheels 29, 30. In this embodiment a higher required shifting force can be admitted at the sleeve 11 than in case of hand-driven shifting. Under these circumstances an arrangement of dog teeth as shown in a schematic section in FIG. 4 is preferred due to its simplicity and reduced axial dimensions. Here, dog teeth 14, 21, 35 and 36 of sleeve 11, the two baulk rings 16, 17 and the gearwheels 29, 30 have identical roof angles α between their facets and the axial direction. The roof angle α is approximately 58.5°, which is uncommonly large for a synchronizer with nested friction rings. Due to the large roof angle α, the baulk ring 16 can be made narrower than usual for a nested setup. Similarly, the axial dimension of facets 36 at the tips of the dog teeth 35 of gearwheel 29 can be made small. Since the roof angles are the same at the two baulk rings 16, 17 and the two gearwheels 29, 30, a higher shifting force is required for synchronizing gearwheel 29 than for synchronizing gearwheel 30. An electronic controller of the actuator takes account of this fact by controlling the actuator to produce different shifting forces depending on its direction of displacement, so that synchronization takes approximately the same time for both gearwheels 29, 30.

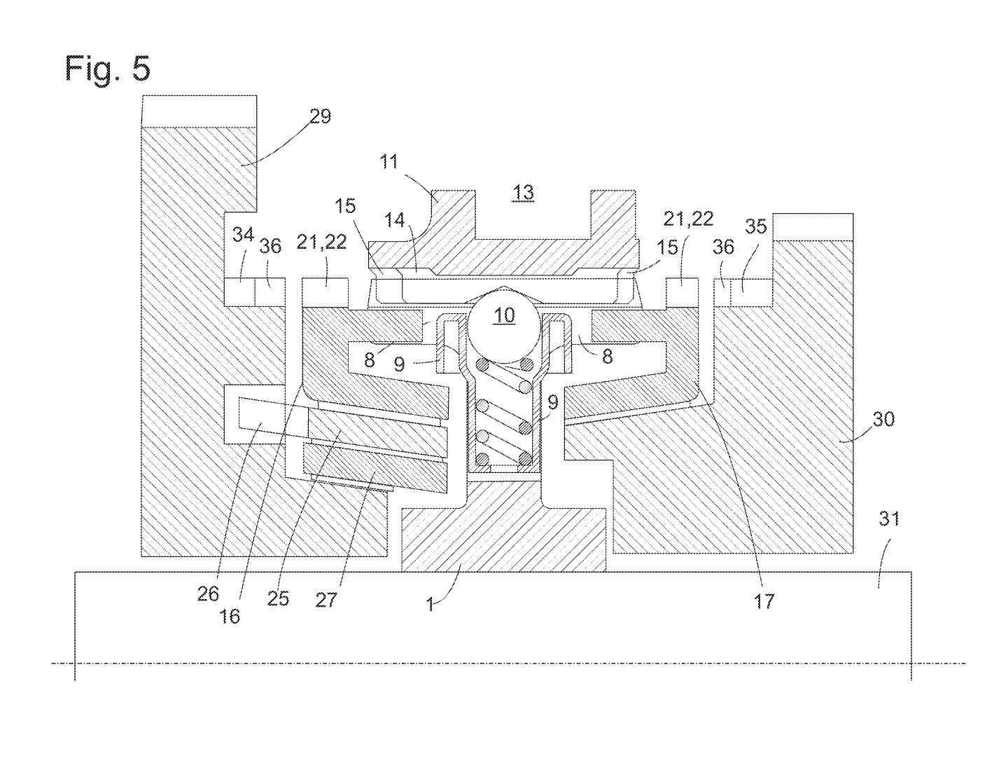

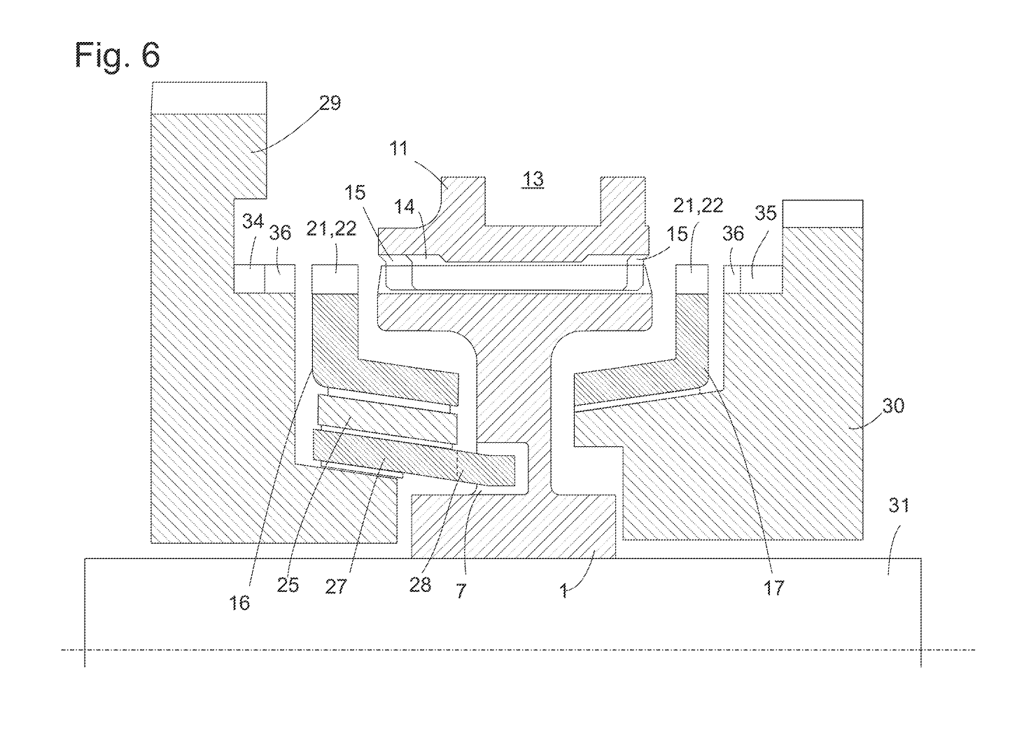

As pointed out above, the circular web 19 may be missing in baulk ring 16. FIGS. 5 and 6 are sections, analogous to FIG. 2 and FIG. 3, of a transmission where the baulk ring 16 has no such web. The other details of this transmission are the same as described referring to FIGS. 1 to 3, and will not be repeated here. The space formerly occupied by web 19 is now occupied by friction rings 25 and 27, so that the friction surface is substantially larger than in the first embodiment. Instead of making the friction rings broader, the distance between hub 1 and gearwheel 30 might have been reduced, making the synchronizer still more compact, or the width of the disk 3 of hub 1 might have been increased. Of course, the synchronizer of FIGS. 5 and 6 may have dog teeth as described referring to FIG. 4, too.

In a practical embodiment of a transmission, one or more synchronizers of the types shown in FIG. 1 to FIG. 6 may be provided, and they can be combined with double-acting synchronizers having friction rings at both sides of the hub or having no friction rings at all, or with single-acting synchronizers as appropriate.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment of the invention, it being understood that various changes may be made in the function and arrangement of elements described in an exemplary embodiment without departing from the scope as set forth in the appended claims and their legal equivalents.

1. A double-acting synchronizer, comprising:
a shaft;
a first gearwheel mounted on the shaft;
a second gearwheels rotatably mounted on the shaft;
a sleeve that is axially displaceable along the shaft between a first position that locks the first gearwheel to the shaft and a second position that locks the second gearwheel to the shaft;
a first baulk ring;
a second baulk ring,
a single conical friction surface that is formed between the first baulk ring and the first gearwheel; and
a plurality of nested conical friction surfaces that are formed between the second baulk ring and the second gearwheel.

2. The synchronizer of claim 1,
wherein the first baulk ring and the second baulk ring comprise dog teeth with oblique facets facing the sleeve, and
wherein the oblique facets of the second baulk ring are steeper than the oblique facets of the first baulk ring.

3. The synchronizer of claim 1,
wherein the sleeve comprises dog teeth with oblique facets facing the first baulk ring and the second baulk ring, and
wherein the oblique facets facing the second baulk ring are steeper than the oblique facets facing the first baulk ring.

4. The synchronizer of claim 1,
wherein the first baulk ring and the second baulk ring comprise dog teeth with oblique facets facing the sleeve, and
wherein the oblique facets of the first baulk ring and the second baulk ring have substantially identical roof angles.

5. The synchronizer of claim 1, wherein the dog teeth of at least the second baulk ring have a roof angle of at least approximately 50°.

6. The synchronizer of claim 5, wherein the roof angle is between approximately 55° and approximately 60°.

7. The synchronizer of claim 1, further comprising an actuator configured to displace the sleeve.

8. The synchronizer of claim 1, wherein a friction ring nested within second baulk ring is in direct form-fitting engagement with a hub of the synchronizer.

9. The synchronizer of claim 1,
wherein the second baulk ring and a friction ring concentrically locked to said second baulk ring form an annular groove, and
wherein the sidewalls form two of said concentric conical friction surfaces.

10. The synchronizer of claim 1,
wherein the second baulk ring and a friction ring concentrically locked to said second baulk ring form an annular groove, and
wherein an inner surface of said friction ring forming one of said plurality of concentric conical friction surfaces.

11. A transmission comprising;
a shaft;
a first gearwheel mounted on the shaft;
a first gear associated with the first gearwheel;
a second gearwheels rotatably mounted on the shaft;
a second gear associated with the second gearwheel, the second gear is lower than the first gear;
a sleeve that is axially displaceable along the shaft between a first position that locks the first gearwheel to the shaft and a second position that locks the second gearwheel to the shaft;
a first baulk ring;
a second baulk ring,
a single conical friction surface that is formed between the first baulk ring and the first gearwheel; and
a plurality of nested conical friction surfaces that are formed between the second baulk ring and the second gearwheel.

12. The transmission of claim 11,
wherein the first baulk ring and the second baulk ring comprise dog teeth with oblique facets facing the sleeve, and
wherein the oblique facets of the second baulk ring are steeper than the oblique facets of the first baulk ring.

13. The transmission of claim 11,
wherein the sleeve comprises dog teeth with oblique facets facing the first baulk ring and the second baulk ring, and
wherein the oblique facets facing the second baulk ring are steeper than the oblique facets facing the first baulk ring.

14. The transmission of claim 11,
wherein the first baulk ring and the second baulk ring comprise dog teeth with oblique facets facing the sleeve, and
wherein the oblique facets of the first baulk ring and the second baulk ring have substantially identical roof angles.

15. The transmission of claim 11, wherein the dog teeth of at least the second baulk ring have a roof angle of at least approximately 50°.

16. The transmission of claim 15, wherein the roof angle is between approximately 55° and approximately 60°.

17. The transmission of claim 11, further comprising an actuator configured to displace the sleeve.

18. The transmission claim 11, wherein a friction ring nested within second baulk ring is in direct form-fitting engagement with a hub of the synchronizer.

19. The transmission of claim 11,
wherein the second baulk ring and a friction ring concentrically locked to said second baulk ring form an annular groove, and
wherein the sidewalls form two of said concentric conical friction surfaces.
The synchronizer of claim 1,
wherein the second baulk ring and a friction ring concentrically locked to said second baulk ring form an annular groove, and
wherein an inner surface of said friction ring forming one of said plurality of concentric conical friction surfaces.
